(19) United States
(12) Patent Application Publication
(10) Pub. No.: US 2012/0123850 A1
(43) Pub. Date: May 17, 2012

(54) SYSTEM AND METHOD FOR ACTIVELY RANKING AND FILTERING INFORMATION

(75) Inventors: Yenyu CHEN, Taipei (TW); Yung-Chuan Jimi WEN, Taipei (TW)

(73) Assignee: HAISON TECHNOLOGY INC., Taipei (TW)

(21) Appl. No.: 12/944,077

(22) Filed: Nov. 11, 2010

(51) Int. Cl. G06Q 30/00

(52) U.S. Cl. 705/14.36; 705/14.1

(57) ABSTRACT

One embodiment of the present invention sets forth a method, which includes receiving a request for specific information, wherein the request is associated with a first reward limit and a second reward limit, determining a first reward amount within the first reward limit based on a number of information providers, receiving personal data and a wager from each of the information providers, distributing the first reward amount to at least one of the information providers in a first phase based on a ranking of relevancy of submitted information by the information providers, and distributing the second reward amount in a second phase based on a result of using the submitted information.

### BACKGROUND OF THE INVENTION

### Description of the Related Art

In certain specialized fields, such as the field relating to intellectual property (“IP”) laws, the needs to retrieve and access publicly accessible information have increased tremendously due to the litigious nature of such fields. Specific information is often needed to evaluate the validity, scope, and enforceability of certain IP rights, such as patent rights.

One traditional approach is for a requester of the information to rely on a professional search firm to sort through all the relevant data to identify information that satisfies the needs of the requester. However, when relying on the professional search firm, the requester is likely to encounter any or all of the following problems: 1) the professional search firm provides a substantial amount of search results without much meaningful organization or explanation. For the requester to make sense of the search results, the requester still needs to spend considerable amount of time to review the search results; 2) the professional search firm often lacks the expertise in the field where information is sought. Thus, it often fails to identify or even consider the most relevant information that the requester needs; and 3) the professional search firm is often costly.

Because of the popularity and accessibility of the Internet and the World Wide Web, a significant amount of information is uploaded onto it daily. Thus, another approach is for the requester to use any of the web-based search engines to conduct searches on the Internet. However, the requester is still likely to face any or all of the problems mentioned above. For instance, the search results generated by the search engines are unlikely to be tailored to the needs of the requester, because the search engines already have established search and output algorithms. Without explanations for the search results, the requester is again forced to spend much time to evaluate the voluminous search results. Similar to the traditional approach of employing a third party, the cost and efficiency of conducting such Internet searches still heavily depends on the qualifications of the individual designated by the requester to perform the searches and also the individual's familiarity of the field in which the information is requested.

As has been illustrated, what is needed in the art is thus a method and apparatus for cost-effectively ranking and filtering the requested information in a specialized field by leveraging the resources provided by the Internet.

### SUMMARY OF THE INVENTION

One embodiment of the present invention sets forth a method, which includes receiving a request for specific information, wherein the request is associated with a first reward limit and a second reward limit, determining a first reward amount within the first reward limit based on a number of information providers, receiving personal data and a wager from each of the information providers, distributing the first reward amount to at least one of the information providers in a first phase based on a ranking of relevancy of submitted information by the information providers, and distributing the second reward amount in a second phase based on a result of using the submitted information.

### BRIEF DESCRIPTION OF THE DRAWINGS

So that the manner in which the above recited features of the present invention can be understood in detail, a more particular description of the invention, briefly summarized above, may be had by reference to embodiments, some of which are illustrated in the appended drawings. It is to be noted, however, that the appended drawings illustrate only typical embodiments of this invention and are therefore not to be considered limiting of its scope, for the invention may admit to other equally effective embodiments.

FIG. 1 is a simplified block diagram of a system 100 configured to perform one or more aspects of the present invention;

FIG. 2 is a general equation 202 for determining a phase one reward of an interactive rewarding mechanism;

FIG. 3 illustrates an example of a set of weighing factors corresponding to different Reward Conditions, according to one embodiment of the present invention;

FIG. 4 illustrates an active filtering and ranking system 400 that helps to compile the importance index, according to one embodiment of the present invention;

FIG. 5 is a flow diagram illustrating a process 500 followed by a server/controller, according to one embodiment of the present invention;

FIG. 6 is a flow diagram illustrating a process 600 followed by a registered requester making a request to the system 100, according to one embodiment of the present invention;

FIG. 7 is a flow diagram illustrating a process 700 followed by a registered provider submitting information to the system 100, according to one embodiment of the present invention;

FIG. 8 is a flow diagram illustrating a process 800 followed by a registered requester after receiving the filtered and ranked information, according to one embodiment of the present invention;

FIG. 9 is a flow diagram illustrating a maintenance procedure 900 performed a server/controller, according to one embodiment of the present invention; and

FIG. 10 is a simplified block diagram of an embodiment of a computer device 1000 configured to perform the functions of a requester, a provider, a reviewer, or a server/controller, according to one embodiment of the present invention.

### DETAILED DESCRIPTION

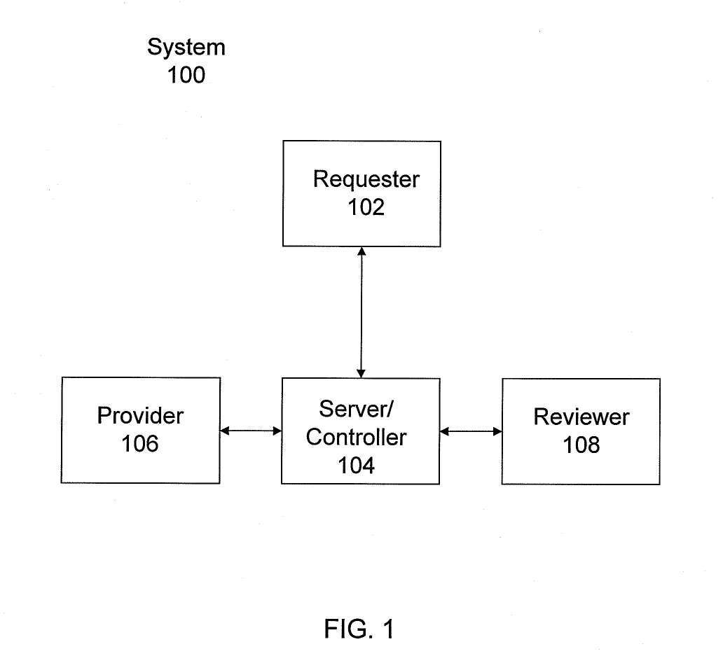

The present invention relates to a method and apparatus for actively ranking and filtering information using an interactive rewarding system. FIG. 1 is a simplified block diagram of a system 100 configured to perform one or more aspects of the present invention. The system 100 includes a requester 102, a server/controller 104, a provider 106, and a reviewer 108. The requester 102 specifies its needs in a request and sends the request to the server/controller 104. The server/controller 104 informs all potential providers and reviewers about the request. The server/controller 104 also serves as a data collection and distribution center and manages the data flow among the parties connected to it. In response to the request, the provider 106 provides information, with some level of confidence, to the server/controller 104 that the provider believes should satisfy the request. The reviewer 108 reviews the information provided by the provider 106 and provides its assessment, also with some level of confidence, to the server/controller 104. Throughout this disclosure, the providers and the reviewers who decide to participate in responding to a request are also collectively referred to as “participating parties.”

In accordance with at least some embodiments of the present invention, each of the requester 102, the server/controller 104, the provider 106, and the reviewer 108 may correspond to a computing device configured to carry out certain methods and processes that are illustrated in the figures and described in the following paragraphs.

Each of the components in the system 100 may be connected to one another through network connections. In one implementation, the requester 102, the provider 106, and the reviewer 108 register with the server/controller 104. The registration process requires the requester 102, the provider 106, and the reviewer 108 to enter their personal information into the server/controller 104. The personal information can be used to verify identities of the parties in the system 100. The personal information can also be used as a factor in determining rewards for a participating party. After completing the registration process, the requester 102 can begin sending one or more requests to the server/controller 104. In one implementation, a request includes information such as, without limitation, the descriptions of a problem in which certain information is needed, the type of the requested information, the conditions to receive a reward (“Reward Conditions”), and the descriptions of the award. If the Reward Conditions set by the requester are met, then the reward is distributed.

To illustrate, suppose the requester 102 submits a request R to the server/controller 104. Suppose further that the request R is seeking information that can help the requester 102 potentially invalidate a US patent P. The server/controller 104 makes the request R available to all potential providers and reviewers. In one implementation, the server/controller 104 may publicize the request R on a website that it hosts, where the request R is thus accessible by any Internet user. The request R may include a problem statement and a maximum and minimum amount of allocated payout that the provider 106 may receive. The maximum amount of allocated payout may vary depending on the number of providers 106 participating at the time. As a registered party in the system 100, the provider 106 may decide that it has a certain reference that can satisfy the request R and the Reward Conditions. Depending on the confidence level of the provider 106 regarding the strength of this reference, the provider places a wager. In other words, if the provider 106 has high confidence that the reference to be submitted is of high relevance to the US patent P and has a good chance to invalidate the US patent P, then the provider 106 is likely to place the maximum permissible wager amount so that it can potentially receive the maximum allocated payout. Some examples of the information that the provider 106 may submit include, without limitation, patents from various countries, publications, court judgments, product information, public use or sale information, and any information relating to determining the validity, scope, or enforceability of a patent. After the provider 106's submission, the reviewer 108 is given opportunities to review the submitted information and also to place a wager on the information. Again, the amount of the wager is indicative of the confidence level of the reviewer 108 on the provider 106′s submission. If the submitted information is chosen by the requester 102, then the reviewer 108 may also be rewarded. Subsequent paragraphs will further detail the interactive rewarding system. It should be apparent to a person with ordinary skills in the art to recognize that the provider 106 for one submitted reference may be a reviewer for another reference, and similarly, the reviewer 108 for one submitted reference may also be a provider for another reference.

The server/controller 104 provides a platform that supports filtering and ranking of submitted information, administering an interactive reward system, and managing the data flow among the various parties in the system 100. More specifically, continuing with the example above, when the provider 106 submits information in response to the request R from the requester 102, the server/controller 104 is configured to determine the relevancy of the information. To filter and rank all the information that it has received regarding the request R, the server/controller 104 is configured to judge the strength of the information by evaluating the amounts of the wagers submitted by the participating parties. The server/controller 104 is also configured to consider a set of Reward Conditions set by the requester 102 in the filtering and ranking process. The results from the filtering and ranking process are compiled into an importance index based on the wagers and the set of Reward Conditions. The importance index then is presented to the requester 102 for review. After the requester 102 reviews the information based on the importance index, a grade is provided to selected information from the importance index, reward are then distributed by the server/controller 104 to the providers of the selected information according to the grade received. Information with higher grade receives a higher payout. The provider of the information on the importance index which is not graded may receive a full refund. Subsequent paragraphs further detail the filtering and ranking process.

The interactive reward system provides incentives to attract more providers and reviewers, especially experts in the field relating to the request, to participate in responding to the request R. Having experts who are experienced and skilled in the relevant field ensures the relevance of the submitted information to the request and also improves the efficiency of identifying the requested information. The interactive rewarding system offers several types of incentives, such as monetary rewards and name recognition.

Referring back to FIG. 1 to illustrate this interactive rewarding system, when the requester 102 submits the request R to the server/controller 104, it also submits an amount of monetary reward and the Reward Conditions associated with this request. When the request R is published, the Reward Conditions are also published so that the potential providers and reviewers understand the odds of winning the monetary reward and the amount of the potential payout.

In one implementation, the amount of monetary reward in the interactive rewarding system includes a phase one reward and a phase two reward. The phase one reward may correspond to a first reward amount that is within a first reward limit, and the phase two reward may correspond to a second reward amount that is within a second reward limit. The first reward limit and the second reward limit may be determined by the requester 102. The phase one reward may be distributed to the providers whose submitted information is selected by the requester 102. The phase two reward may be distributed to the providers who received the phase one reward and also submitted information that contributes to a positive final result of the request R. In one implementation, the monetary reward for the phase two reward is a fixed amount reward.

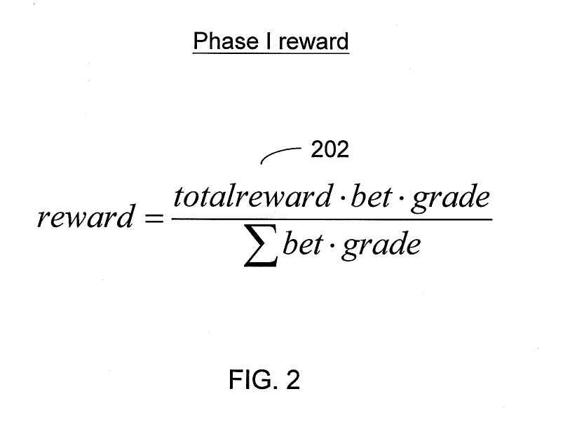

The phase two reward may be distributed according to different scenarios. In one scenario, if the selected information contributes to the requester 102 to successfully invalidate a key patent P and therefore resulting in a victory of a law suit, then a high percentage (e.g., 100%) of the phase two reward will be distributed to the information provider that brought the selected information to the requester 102. In another scenario, if the selected information contributes to the requester 102 to settle a law suit (as opposed to winning it), then less than a high percentage (e.g., 50%) of the phase two reward will be distributed to the information provider. However, in yet another scenario, if the selected information does not contribute to the requester 102 to either win or settle a law suit, then a low percentage (e.g., 0%) of the phase two reward will be distributed to the information provider. However, since phase one reward is distributed regardless of the outcome of the request R, there are still incentives for the provider and the reviewer to continue to provide and review information. The calculation of the monetary reward for the phase one reward, in one implementation, is represented by an example general equation 202 shown in FIG. 2. The portion of the monetary reward for the phase one reward that is received by the potential providers may be divided according to the number of potential providers.

As shown in FIG. 2, reward in the general equation 202 corresponds to the amount of payout that a potential provider may receive in phase one; totalreward corresponds to the portion of the monetary reward provided by the requester 102 to cover the phase one reward; bet corresponds to the amount of wager from the potential provider 106; and grade is provided from the requester 102 as discussed above. More specifically, continuing with the example above, when the requester 102 sends in the request R, a totalreward, which corresponds to the first reward amount within the first reward limit in phase one, is also submitted. So, the general equation 202 may be used to determine the maximum monetary reward in phase one for a selected winner based on the selected winner's own bet and the grade received from the requester 102. In one implementation, a range for the first reward amount based on a number of information providers 106 may be calculated by the controller 104 and may be outputted to the information providers 106. The information providers 106 may submit their bets according to the range. As previously mentioned, the information providers' confidence on the submitted information may reflect on the bets that the information providers 106 submit. Therefore, a higher amount of reward may be received by the information provider 106 who submits a higher bet.

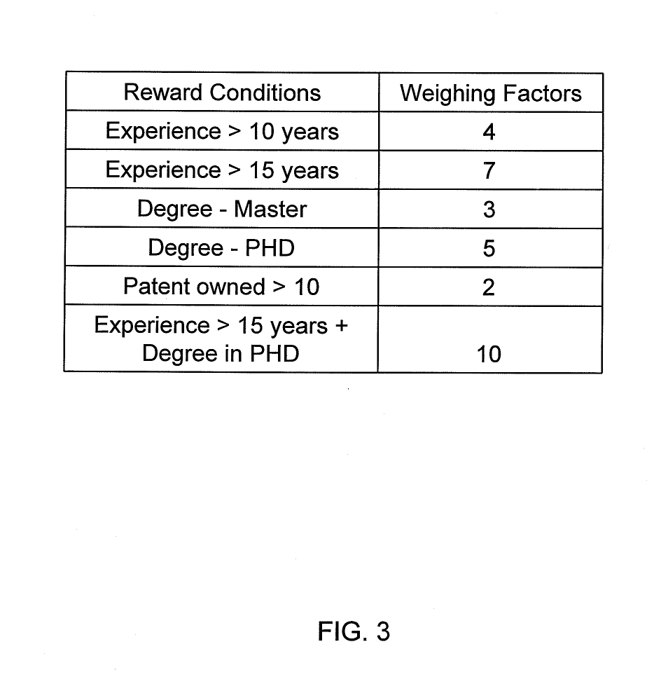

The weighing factors are associated with the Reward Conditions set by the requester 102. Without limitation, some examples of these conditions include the background, relevant experience, and education level of the provider 106. In some instances, the requester 102 also considers the number of patents the provider 106 is named as an inventor. FIG. 3 illustrates an example of a set of weighing factors corresponding to different Reward Conditions, according to one embodiment of the present invention. For instance, the requester 102 may value the relevant experience of the participating party more than the number of patents in which the participating party is an inventor. Thus, the requester 102 assigns a higher weighing factor for the relevant experience (e.g., 7 for 15 years of relevant experience) than for the number of patents (e.g., 2). It should be apparent to a person with ordinary skills in the art to recognize that the conditions shown in FIG. 3 are for illustration purposes only and shall not be construed to limit the scope of the claimed invention.

It should be apparent to a person with ordinary skills in the art to recognize that the general equations of FIG. 2 can be modified to take into account of other scenarios without exceeding the scope of the claimed invention. For example, the equations may be modified to properly compensate a single participating party for making multiple relevant submissions while preventing anyone from disrupting the normal operations the system. Also, the equation may be modified to accommodate having two distinct sets of permissible wager amount and potential payout. One is for providers, another is for reviewers. The equation may also be modified to include or eliminate one or more elements shown in FIG. 2.

In one implementation, a participating party receives an initial credit line after completing the registration process discussed above and uses the credit line to place wagers. The credit line can be adjusted based on the behavioral patterns of the participating party. So, if the participating party has a history of making good-faith submissions, having submissions chosen, or transferring money to exchange for additional credits, then the credit line of this party can be increased. On the other hand, if the participating party has a history of disrupting the normal operations of the interactive reward system, then the credit line associated with the party can be decreased or even revoked completely.

For the name recognition reward, in one implementation, after the requester 102 of FIG. 1 selects a particular submission, the identity of the provider is published. Suppose the submission from the provider 106 in response to the request R is chosen. On the website where the request R is initially published, the identity of the provider 106 can be prominently displayed along with the request. Moreover, the requester 102 may also publish positive comments on the selected submission or even the provider 106. As the provider 106 is seen in a positive light more frequently, the provider 106 becomes known and gains trust and respect of others. As a result, subsequent submissions from the provider 106 are more likely to be considered than others.

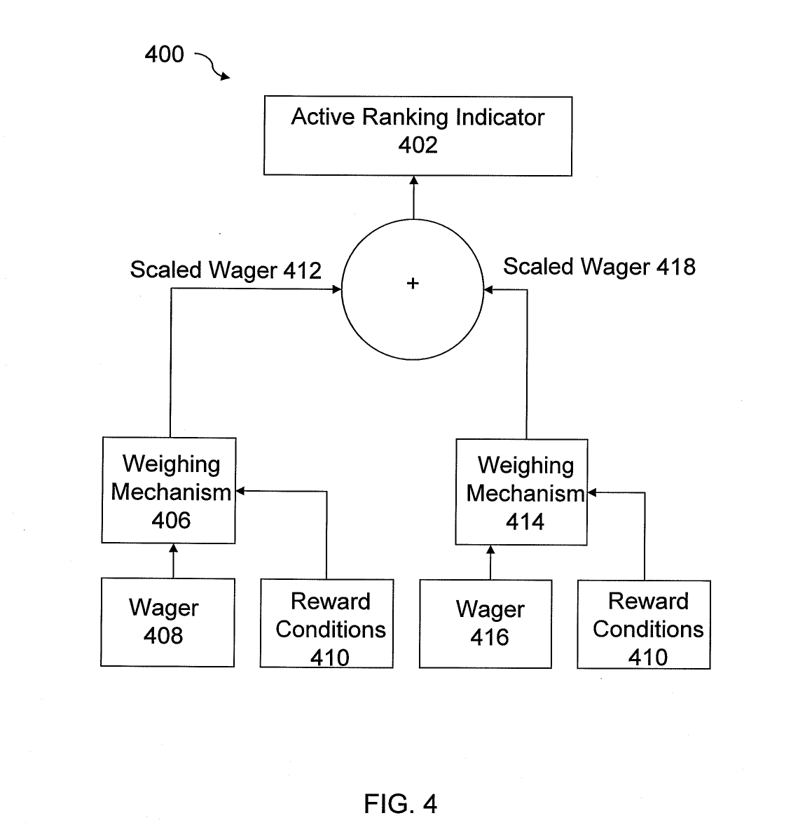

In addition to the interactive reward system described above, the weighing factors that are associated with the Reward Conditions are also utilized in forming the importance index as previously discussed. FIG. 4 illustrates such an active filtering and ranking system 400 that helps to compile the importance index, according to one embodiment of the present invention. An active ranking indicator 402 is used to filter, rank, and then show the ranking of the information submitted by the providers for a particular request. Here, the active ranking indicator 402 performs a first level of “filtering” by comparing the information associated with a participating party and also the submitted reference of the participating party with the Reward Conditions 410 associated with a specific request, such as request R. For example, suppose the Reward Conditions 410 correspond to the set of conditions shown in FIG. 3. If the participating party fails to satisfy any of the listed conditions, such as not having the relevant work experience, then one implementation of the active ranking indicator 402 filters out the submitted reference from this participating party. In other words, submissions made by such a non-qualified participating party are not considered. It should be apparent to a person with ordinary skills in the art to recognize that the Reward Conditions can also include conditions associated with the information sought (e.g., the type of information sought) without exceeding the scope of the present invention.

In addition to the aforementioned first level of filtering, a second level of filtering, enabled by the system 100 of FIG. 1, is performed by the participating parties. Specifically, by forcing the participating parties to put personal stakes behind their submissions, the actively filtering and ranking system 400 essentially looks to the participating parties to weed out any irrelevant or unimportant information. To further organize the filtered results, in one implementation, the results are ranked based on the wagers placed by the participating parties and also the weighing factors associated with these parties. To illustrate, suppose a wager 408 is submitted by a provider, and a wager 416 is submitted by a reviewer regarding a particular submitted reference SR0 for the same request R. As discussed above, according to the requester's Reward Conditions, the wager 408 and the wager 416 are scaled by a weighing mechanism 406 and a weighing mechanism 414, respectively. Some example weighing mechanisms include, without limitation, a multiplication operation (e.g., scaled wager 412=constant+wager 408×a weighing factor; or scaled wager 412=C+C₁×wager 408+C₂×(wager 408)²+C₃×(wager 408)³+ . . . +Cₙ×(wager 408)ⁿ, wherein C's refer to various constants), an exponential operation (e.g., scaled wager 412=C+N×(wager 408)^{Weighing Factor}, wherein C refers to a constant and N refers to a multiplier), and a lookup operation. Some example lookup tables having entries that correspond to (scaled wager 412=wager 408×multiplier) may look like:

For a provider without special qualifications:

| Wager 408 | <100 | >100 and <1000 | >1000 |
|---|---|---|---|
| Multiplier | 50 | 40 | 30 |

For a provider with special qualifications:

| Wager 408 | <100 | >100 and <1000 | >1000 |
|---|---|---|---|
| Multiplier | 100 | 90 | 80 |

The scaled wager 412 and the scaled wager 418 are aggregated to establish a combined numerical score indicative of the collective confidence of the participating parties on the submitted reference SR0. Then, the active ranking indicator 402 compares all the numerical scores of the submitted references for the request R to determine the appropriate ranking among the submitted references.

In one implementation, the scaled wager 412 and the scaled wager 418 are represented by a dollar amount. Thus, the numerical score for each reference is also represented by a dollar amount. The active ranking indicator 402 then ranks the submitted references according to the dollar amounts. The reference associated with the largest dollar amount is ranked the highest and is considered as the most important reference, whereas the least dollar amount is ranked the lowest and is considered as the least important reference. After all the information has been ranked according to the dollar amount, the ranked results are compiled into the importance index and sent to the requester for review.

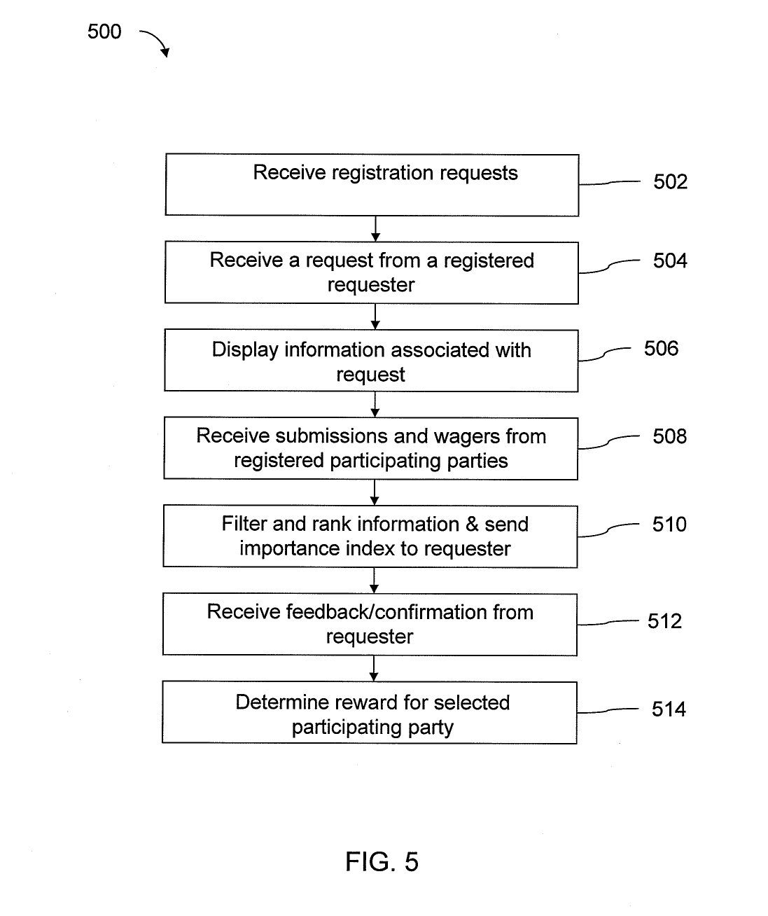

FIG. 5 is a flow diagram illustrating a process 500 followed by a server/controller, according to one embodiment of the present invention. As discussed above, before any request and wager can be submitted, a registration process is needed. In conjunction with FIG. 1, in step 502, the server/controller 104 receives registration requests from parties such as the requester 102, the provider 106, and the reviewer 108. In response to the requests, the server/controller 104 verifies the authenticity of the identity information of the requesting parties. In one implementation, the server/controller 104 may work with various credit reporting companies, educational and governmental institutions, or other third party verification entities to conduct the necessary background checks. After verification, the requesting parties are registered with the system 100. The server/controller 104 then processes the request, such as the request R, from the registered requester 102 in step 504.

Once the request R and other information associated with the request R (e.g., the Reward Conditions) is published to all potential providers and reviewers in step 506, in one implementation by displaying on the Internet, the server/controller 104 typically begins receiving information such as, without limitation, submitted information in response to the request R and wager amounts from a provider, such as the provider 106, and selected references to review and the wager amount from a reviewer, such as the reviewer 104 in step 508. The server/controller 104 categorizes these different received data types and stores them in a storage device. This storage device can be internal or external to the server/controller 104. The server/controller 104 filters and ranks the received data according to the system illustrated in FIG. 4 and detailed above and sends the results as importance index to the requester 102 for final review in step 510. After the requester 102 completes the review of the results, the requester 102 sends back its feedback and confirmation (e.g., the selected submission, the identity of the participating party making the submission, and possibly comments on the selected submission and the participating party) to the server/controller 104 in step 512. The server/controller 104 then determines the appropriate reward according to the appropriate reward phase for the selected participating party in step 514. As has been shown, not only is the server/controller 104 is potentially required to manage a significant amount of data from various parties, but the server/controller 104 also needs to attract a competent group of providers and reviewers to work on the requester's request and properly administer the interactive reward system and the active filtering and ranking system.

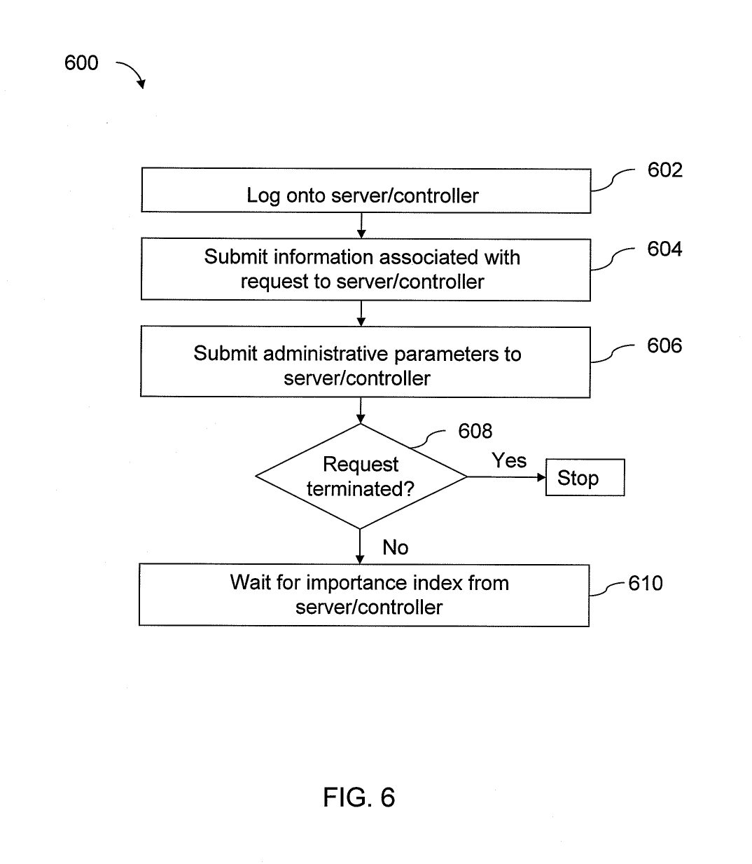

FIG. 6 is a flow diagram illustrating a process 600 followed by a registered requester, such as the requester 102 of FIG. 1, making the request R to the system 100, according to one embodiment of the present invention. After the requester 102 registers with the server/controller 104, the requester 102 logs onto the server/controller 104 in step 602. The requester 102 then submits the relevant information associated with the request R in step 604. Some examples of the relevant information include, without limitation, a problem description and the Reward Conditions. The problem description clearly sets forth the background for the request. The Reward Conditions, in one implementation, also include two parts, a first set of parameters for the controller/server 104 to filter and rank the received submissions, and a second set of parameters focuses on the terms of rewarding the selected participating party. Some or all of the Reward Conditions are published to all the potential providers and reviewers for consideration. In one implementation, these two sets of the parameters are the same. Alternatively, although some commonality exists, the first set of the parameters differs from the second set of the parameters. For example, the second set of parameters may include specific payment terms, which are not in the first set of parameters. To illustrate, one type of the payment arrangement is for the requester 102 to make a one-time lump sum payment after the selection of a particular reference. Another type is for the requester 102 to make milestone payments, such as paying for a percentage of the total reward after the selection is made but delaying the payment of the remaining amount until a certain goal of the requester 102 is reached (e.g., the targeted patent is successfully invalidated). Yet another type is for the requester 102 to pay upon the occurrence of certain events. For instance, if the submitted reference is anticipated to be used in a particular stage of a court proceeding, then the payment is made if such a stage of the court proceeding is reached.

In step 606, the requester 102 submits certain administrative parameters for the server/controller 104. For example, the requester 102 may want the server/controller to delay publishing some or all of the submitted references, so that the requester 102 has a chance to review the information before others know what information the requester 102 has. In addition, the requester 102 may impose an expiration date on the request. After the expiration date, the reward offered by the requester is no longer available, and the request is effectively terminated. If the requester 102 selects all the needed references from the submissions, then the request is also terminated. So, before the request is deemed terminated in step 608, the requester 102 waits for the server/controller 104 to provide the importance index in step 610.

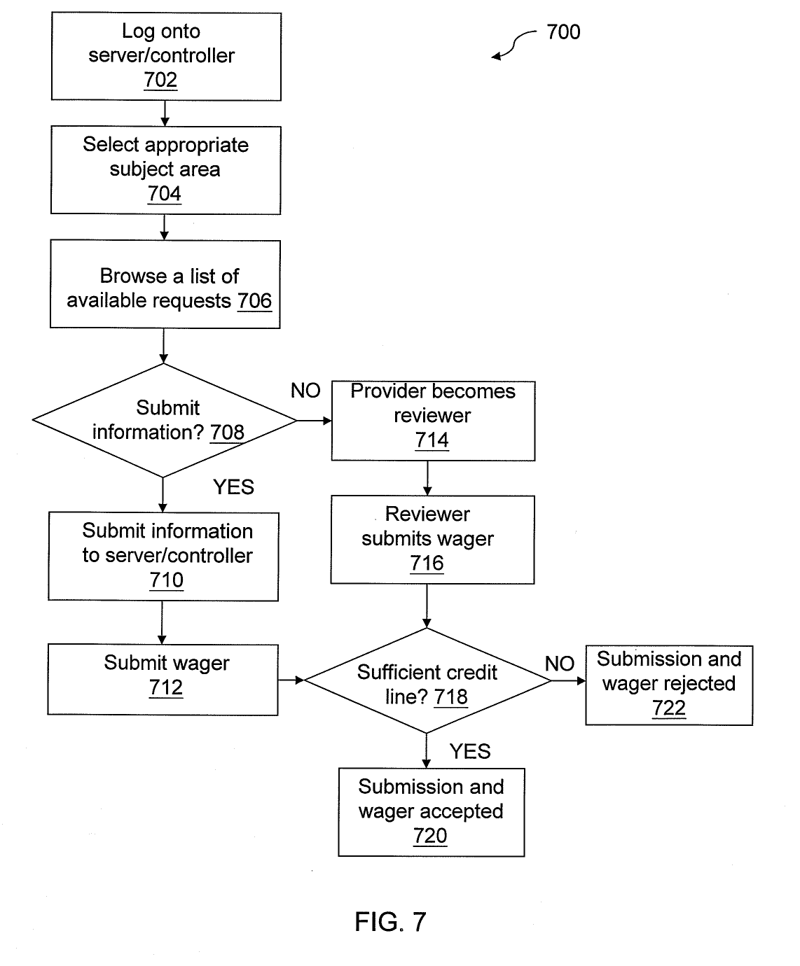

FIG. 7 is a flow diagram illustrating a process 700 followed by a registered provider, such as the provider 106 of FIG. 1, to submit information, according to one embodiment of the present invention. After the provider 106 logs onto the server/controller 104 in step 702, it selects an appropriate subject area in step 704. Then, in step 706, the provider 106 browses through a list of available requests that have not terminated yet. The provider 106 checks with the server/controller 104 in step 708 whether the provider 106 is eligible to submit information to any of the available requests. If the server/controller 104 responds positively, the provider 106 submits information for a particular request to the server/controller 104 in step 710. Then, the provider 106 also places a wager indicative of its confidence level in the submitted information in step 712. On the other hand, if the server/controller 104 responds negatively, then the provider 106 may still become a reviewer in step 714 and browses through information already submitted by others. After browsing through the various submissions, the provider 106, playing the role of a reviewer, can place a wager in step 716. The server/controller 104 checks whether the provider 106 has sufficient credit line to pay for the submitted wager in step 718 and either accepts or rejects the information submission and the wager from the provider 106 in step 720 or in step 722, respectively.

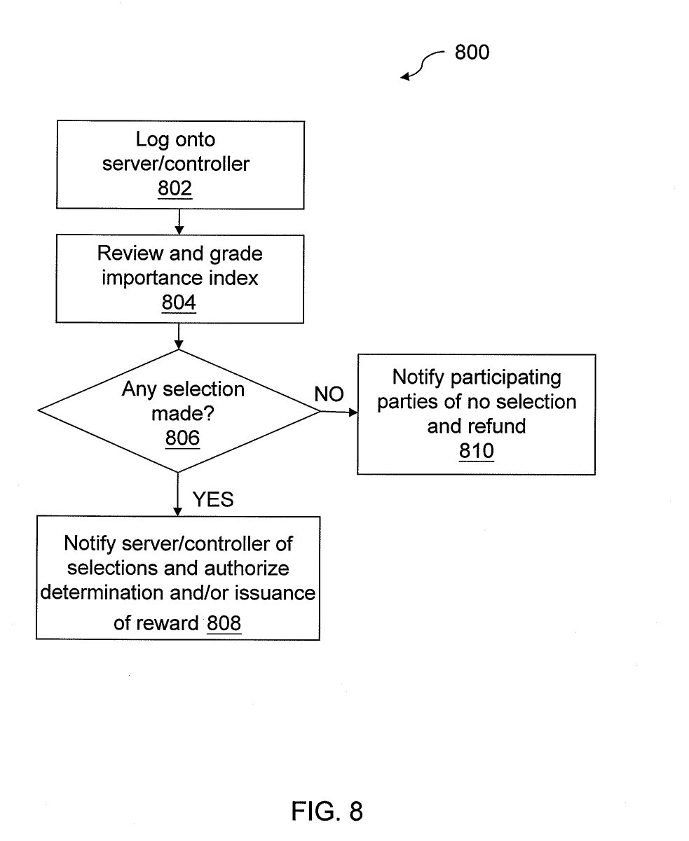

FIG. 8 is a flow diagram illustrating a process followed by a registered requester, such as the requester 102 of FIG. 1, after receiving the filtered and ranked information, according to one embodiment of the present invention. After the requester 102 logs into the server/controller 104 in step 802, the requester 102 has access to the importance index results. The requester 102 reviews the results in step 804 and decides whether to select and grade any of the references from the importance index. To perform timely reviews of the results, in one implementation, the requester 102 sets a number of trigger conditions. For example, the requester 102 is alerted to review the results, if the trigger condition of having a certain number of submitted references, with each of which corresponding to or exceeding a particular numerical score, is met. In other words, if there are enough worthy candidates to review (i.e., submissions with high numerical scores), then the requester 102 is alerted to do so. If the requester 102 makes selections in step 806, then the requester 102 also notifies the server/controller 104 of the selections and effectively authorizes the server/controller 104 to determine and/or issue the reward in step 808. However, if no selections are made, then the requester 102 may cause the server/controller 104 to inform the participating parties in step 810 and refund may be provided to the participating parties.

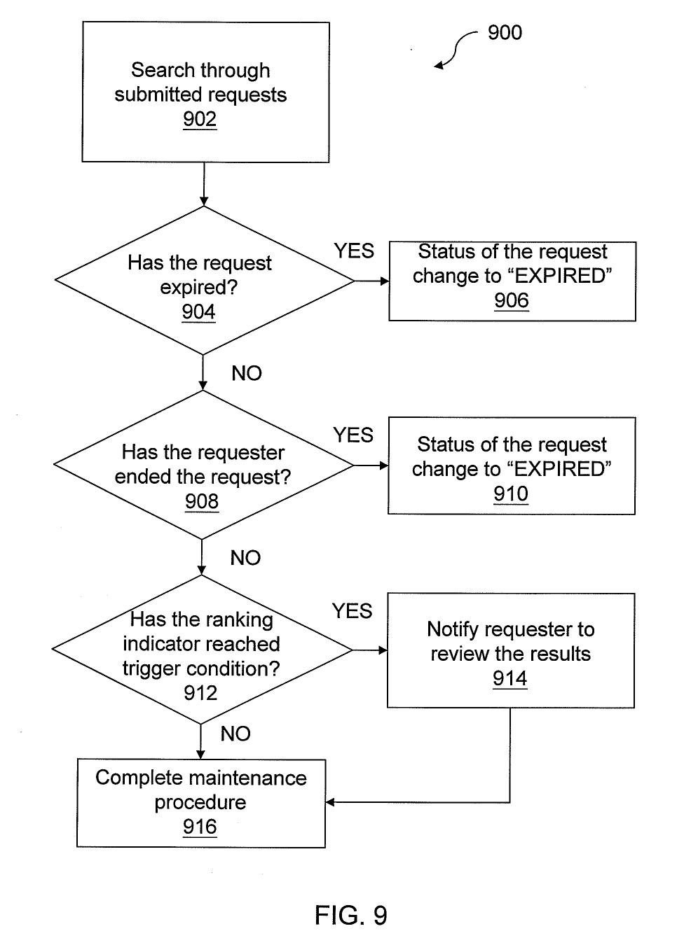

FIG. 9 is a flow diagram illustrating a maintenance procedure 900 performed a server/controller, such as the server/controller 104 of FIG. 1, according to one embodiment of the present invention. In step 902, the server/controller 104 periodically searches through all the submitted requests to see whether any of the requests needs to be cleared out. In one implementation, if a request is found to have expired in step 904, then the server/controller 104 then changes the status of the request to “EXPIRED” and removes the request in step 906. On the other hand, the server/controller 104 proceeds to check in step 908 whether it has received any indication from the requester 102 to terminate the request. If so, the server/controller 104 similarly changes the status of the request to “EXPIRED,” terminates the request, and removes the request in step 910. Otherwise, the server/controller 104 checks whether any of the trigger conditions, if any, is met in step 912. If so, the server/controller 104 notifies the requester 102 to review the importance index result in step 914. If not, the server/controller 104 completes this iteration of the maintenance procedure in step 916.

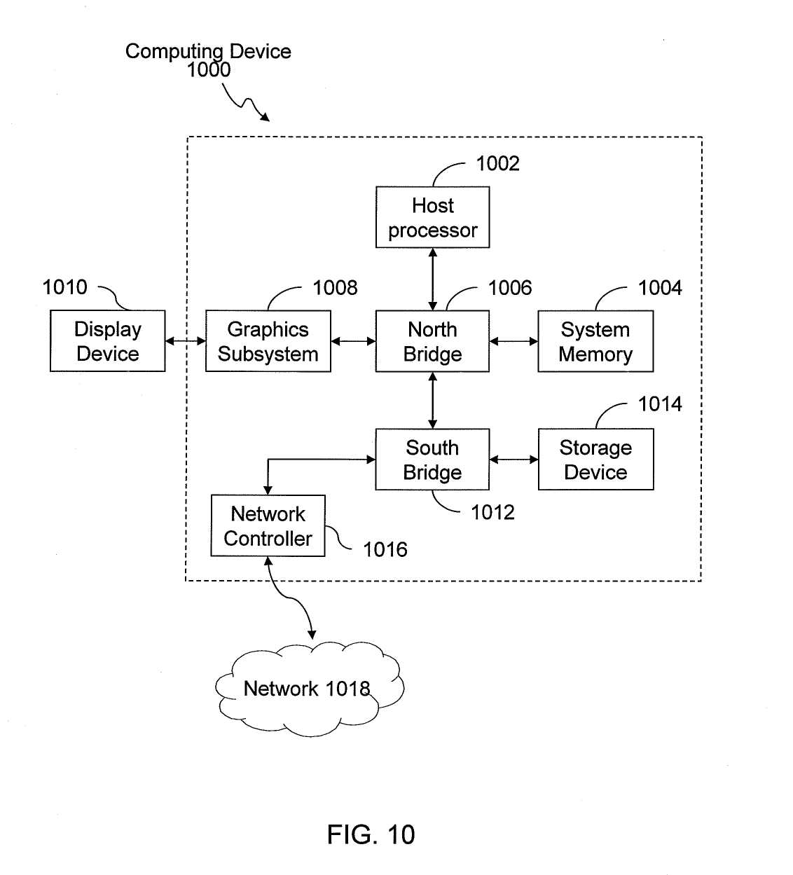

FIG. 10 is a simplified block diagram of an embodiment of a computer device 1000 configured to perform the functions of a requester, a provider, a reviewer, or a server/controller, according to one embodiment of the present invention. The computing device 1000 includes a host processor 1002, system memory 1004, a north bridge 1006 that is directly coupled to a graphics subsystem 1008, and a south bridge 1012 that is coupled to a storage device 1014 and a network controller 1016. The graphics subsystem 1008 is further coupled to a display device 1010, and the network controller 1016 is coupled to a network 1018, such as the Internet. The display device 1010 is an output device capable of emitting a visual image corresponding to an input data signal. For example, the display device 1010 may be built using a cathode ray tube (CRT) monitor, a liquid crystal display, a plasma display, a rear-projection display, or any other suitable display system.

The host processor 1002 executes programming instructions stored in the system memory 1004 to operate on data also stored in the system memory 1004. In alternate embodiments, the host processor 1002, the graphics processing unit in the graphics subsystem 1008, the north bridge 1006, the south bridge 1012, or any combination thereof, may be integrated into a single processing unit. Referring back to FIG. 1, each of the components in the system 100 is associated with its distinct set of programming instructions. In addition, each component in the system 100 also may have different hardware requirements. For instance, the computing device for the server/controller 104 may require a faster host processor and a larger storage device than the computing device for the reviewer 108.

The Computing device 1000 may be implemented as a portion of a small-form factor portable (or mobile) electronic device such as a cell phone, a personal data assistant (PDA), a personal media player device, a tablet computing device, a personal headset device, an application specific device, or a hybrid device that include any of the above functions.

One embodiment of the disclosure may be implemented as a program product for use with a computer system. The program(s) of the program product define functions of the embodiments (including the methods described herein) and can be contained on a variety of computer-readable storage media. Illustrative computer-readable storage media include, but are not limited to: (i) non-writable storage media (e.g., read-only memory devices within a computer such as CD-ROM disks readable by a CD-ROM drive, DVD disks readable by a DVD driver, ROM chips or any type of solid-state non-volatile semiconductor memory) on which information is permanently stored; and (ii) writable storage media (e.g., floppy disks within a diskette drive, hard-disk drive, CD-RW, DVD-RW, solid-state drive, flash memory, or any type of random-access memory) on which alterable information is stored. Such computer-readable storage media, when carrying computer-readable instructions that direct the functions of the disclosure, are embodiments of the disclosure. Therefore, the above examples, embodiments, and drawings should not be deemed to be the only embodiments, and are presented to illustrate the flexibility and advantages of the disclosure as defined by the following claims.

We claim:

1. A method for actively ranking and filtering information, comprising:
receiving a request for specific information, wherein the request is associated with a first reward limit;
determining a first reward amount within the first reward limit based on a number of information providers;
receiving personal data and a wager from each of the information providers; and
determining the first reward amount for at least one of the information providers in a first phase based on a ranking of relevancy of submitted information by the information providers.

2. The method of claim 1, further comprising:
determining a second reward amount in a second phase based on a result of using the submitted information.

3. The method of claim 1, wherein the ranking of relevancy of submitted information further comprising:
determining a scaled wager for each of the information providers based on the wager and information associated with each of the information providers; and
comparing sizes of the scaled wagers of the information providers.

4. The method of claim 1, further comprising completing a sign-up process and a log-in process before accepting the request for the specific information.

5. The method of claim 1, further comprising completing a sign-up process and a log-in process before accepting the personal data and the wager.

6. The method of claim 3, wherein the information associated with each of the information providers depends on a condition set forth by a requester making the request for the specific information.

7. The method of claim 6, further comprising:
sending the submitted information to the requester for confirmation; and
receiving a grade for selected information, wherein the grade is used to determine the first reward amount.

8. The method of claim 7, further comprising refunding the wager if the grade is not received.

9. The method of claim 7, wherein the first reward amount is calculated from the first award limit, the wager, and the grade.

10. The method of claim 1, further comprising presenting the first award limit to solicit the wager.

11. A computer-readable medium containing a sequence of instructions executable within a computing device including a processing unit and a physical memory, wherein the sequence of instructions, when executed by the processing unit, causes the processing unit to:
receive a request for specific information, wherein the request is associated with a first reward limit;
determine a first reward amount within the first reward limit based on a number of information providers;
receive personal data and a wager from each of the information providers; and
determine the first reward amount for at least one of the information providers in a first phase based on a ranking of relevancy of submitted information by the information providers.

12. The computer-readable medium of claim 11, further containing a sequence of instructions, which when executed by the processing unit in the computing device, causes the processing unit to determine a second reward amount in a second phase based on a result of using the submitted information.

13. The computer-readable medium of claim 11, further containing a sequence of instructions, which when executed by the processing unit in the computing device, causes the processing unit to:
determine a scaled wager for each of the information providers based on the wager and information associated with each of the information providers; and
compare sizes of the scaled wagers of the information providers.

14. The computer-readable medium of claim 11, further containing a sequence of instructions, which when executed by the processing unit in the computing device, causes the processing unit to:
send the submitted information to a requester making the request for the specific information for confirmation; and
receive a grade for selected information, wherein the grade is used to determine the first reward amount.

15. A system for actively ranking and filtering information, comprising:
a controller configured to receive a request for specific information from a requester associated with a first reward limit;
determine a first reward amount within the first reward limit based on a number of information providers;
receive personal data and a wager from each of the information providers; and
determine the first reward amount for at least one of the information providers in a first phase based on a ranking of relevancy of submitted information by the information providers.

16. The system of claim 15, wherein the controller is further configured to determine the second reward amount in a second phase based on a result of using the submitted information.

17. The system of claim 15, wherein the controller is further configured to
determine a scaled wager for each of the information providers based on the wager and the personal data; and
compare sizes of the scaled wagers of the information providers.

18. The system of claim 15, wherein the controller is further configured to
determine a range for the first reward amount; and
display the range to the information providers.

19. The system of claim 18, wherein an amount of the wager submitted by each of the information providers depends on the range.

20. The system of claim 15, wherein the controller is further configured to refund any of the information providers without receiving a grade.

21. The system of claim 15, wherein any of the information providers may also review the submitted information.

22. The system of claim 21, wherein the first reward amount is calculated from the first award limit, the wager, and a grade from the requester.
